(19) United States
(12) Patent Application Publication
(10) Pub. No.: US 2013/0083196 A1
(43) Pub. Date: Apr. 4, 2013

(54) Vehicle monitoring systems

(71) Applicant: Joe Zheng, Cupertino, CA (US)

(72) Inventor: Joe Zheng, Cupertino, CA (US)

(73) Assignee: Sun Management, LLC

(21) Appl. No.: 13/251,226

(22) Filed: Oct. 1, 2011

(51) Int. Cl. H04N 7/18

(52) U.S. Cl. 348/148; 348/E07.085

(57) ABSTRACT

A monitoring system for vehicles is disclosed. At least two cameras are disposed around a vehicle to generate videos or images representing surrounding scenes in which the vehicle is present. Video streams from the cameras are transported via wired means or wireless means to a video processing system. Depending on applications, the video streams are processed to be collectively displayed on a screen (e.g., on the dashboard of the vehicle), analyzed to assist the driver of the vehicle to perform a task, stored in a storage device of limited capacity, or transported to a remote server for remote assistance or analysis.

### BACKGROUND OF THE INVENTION

1. Field of the Invention

The present invention relates generally to an imaging system for a vehicle and, more particularly, to a monitoring system in a vehicle that generates outward surrounding views to assist a driver of the vehicle in various events (e.g., security, curb parking, remote assistance or insurance assessment).

2. The Background of Related Art

There are nowadays a lot of discussions about equipping all new cars with “black boxes” to record crash data. In airplane, a black box, also referred to as flight data recorder, is an electronic device employed to record instructions sent to any electronic systems on an aircraft. It is a device used to record specific aircraft performance parameters, and often includes a cockpit voice recorder (CVR) that records conversations in the cockpit, radio communications between the cockpit crew and others (including conversation with air traffic control personnel), as well as ambient sounds. The data captured in the black box would be primarily used by a law enforcement to investigate an event, although not necessary always an accident.

Although called Event Data Recorder (EDR), a black box in a vehicle is primarily for assisting an investigation of an accident. People have a tendency to think of a black box in a vehicle as they think of a flight-data recorder. But the two event recorders are significantly different as the cars and planes are not only mechanically so different, they are also in very different conditions when being operated. Therefore the data recorded in the two different types of boxes is so different.

Event Data Recorder (EDR) for a vehicle, sometimes a part of an air-bag system, captures the exact speed of the vehicle, an acceleration, braking and other data in a few seconds leading up to a crash. The data in the EDR for a vehicle could be used to analyze why a vehicle fails and gets into a crash. However, the data would not be much useful when the vehicle gets into an accident because of the exterior reasons (e.g., hit by another vehicle).

Thus there is a need for a mechanism that not only records the then conditions of the vehicle but also the surrounding conditions prior to an accident. Besides providing usable data to assist an investigation of a vehicle, such a mechanism can facilitate other services such as remote assistance, security of the vehicle, and parking assistance.

### SUMMARY OF THE INVENTION

This section is for the purpose of summarizing some aspects of the present invention and to briefly introduce some preferred embodiments. Simplifications or omissions in this section as well as in the abstract or the title of this description may be made to avoid obscuring the purpose of this section, the abstract and the title. Such simplifications or omissions are not intended to limit the scope of the present invention.

In general, the present invention pertains to a monitoring system for vehicles. According to one aspect of the present invention, a plurality of cameras are disposed around a vehicle to generate videos or images representing surrounding scenes in which the vehicle is present. The video streams from the cameras are transported via wired means or wireless means to a video processing system. Depending on applications, the video streams are processed to be collectively displayed on a screen (e.g., on the dashboard of the vehicle), analyzed to assist the driver to perform a task, stored in a storage device of limited capacity, or transported to a remote server for remote assistance or analysis.

To provide a surrounding view, a display screen has a set of predefined allocated display areas, each for one of the cameras. According to another aspect of the present invention, video streams are rescaled to fit respective allocated display areas on a display screen. The video streams may also be locally analyzed in a video processing system to provide assistance in cube parking and security monitoring of the vehicle.

According to still another aspect of the present invention, a storage device is provided to cache the video streams for a limited time (e.g., 2 minutes). The video streams are respectively compressed and coupled to the storage device. The compressed video streams are fed to the storage device in a FIFO (first-in-first-out) fashion. The storage device or an enclosure thereof is protected or coupled to a set of sensors that facilitate to shut off the storage device upon detecting that the vehicle has experienced an impact. As a result, the data already stored in the storage device is protected and may be used late to determine what has caused the impact. In general, each of the video streams is embedded with profile data of the vehicle. Examples of the profile data include GPS data, date and time the video is generated, driving direction and speed/acceleration/deceleration the vehicle is going.

According to yet another aspect of the present invention, the compressed video streams may be transported wirelessly to a remote server. Depending on application, the transported data may be used for remote assistance or analysis.

The present invention provides a monitoring system for vehicles. The present invention may be implemented in many forms including a device, a system, a method, or a part of a system. According to one embodiment, the present invention is a monitoring system for a vehicle, the system comprises a plurality of cameras disposed around the vehicle to generate video streams about a scene surrounding the vehicle, a video processing device; a display screen on a dashboard of the vehicle, and a transmission medium to transport the video streams from the cameras to the video processing device for processing to be collectively displayed on the display screen. Some or all of the video streams are respectively displayed in allocated display areas of the display screen. The display areas are reconfigurable to accommodate more or less of the video streams, and the some or all of the video streams provide a driver of the vehicle an outward surrounding view of the vehicle.

According to another embodiment, the present invention is a monitoring system for a vehicle, the system comprises a storage device, a video processing unit configured to receive video streams from at least two cameras disposed around the vehicle, the video processing unit is further configured to compress the video streams and couple the compressed video streams to the storage device, where the storage device has a storage capacity to store video data of a predefined period, the compressed video streams are stored in the storage device in FIFO (first-in-first-out) fashion; and wherein the storage device is coupled to a set of sensors and stops from taking the compressed video streams upon any of the sensors detecting an impact to the vehicle to preserve the data already in the storage device.

According to yet another embodiment, the present invention is a monitoring system for a vehicle, the system comprises a method for monitoring a vehicle, the method comprises generating video streams from at least two cameras disposed around the vehicle, coupling the video streams to a video processing unit configured to compress the video streams, storing the compressed video streams in the storage device, where the storage device has a storage capacity to store video data of a predefined period, the compressed video streams are stored in the storage device in FIFO (first-in-first-out) fashion, and wherein the storage device is coupled to a set of sensors and stops from taking the compressed video streams upon any of the sensors detecting an impact to the vehicle to preserve the data already in the storage device.

One of the objects, advantages and benefits in the present invention is to provide a mechanism to record the behaviors of the vehicle and its surrounding scene in case there is a need to reconstruct the scene after the accident involving the vehicle has occurred.

Other objects, features, and advantages of the present invention will become apparent upon examining the following detailed description of an embodiment thereof, taken in conjunction with the attached drawings.

### BRIEF DESCRIPTION OF THE DRAWINGS

These and other features, aspects, and advantages of the present invention will become better understood with regard to the following description, appended claims, and accompanying drawings where:

FIG. 1A shows an exemplary vehicle equipped with one embodiment of the present invention, referred to as surrounding vehicle video system (SVVS) herein, that provides at least some of the objects, services or benefits in the present invention;

FIG. 1B shows a functional block diagram of an SVVS according to one embodiment of the present invention;

FIG. 2A shows an exemplary functional block diagram of part of an SVVS using a set of analog cameras;

FIG. 2B shows an exemplary functional block diagram of part of an SVVS using a set of digital cameras;

FIG. 2C illustrates a display screen that may be mounted in a dashboard is provided to display videos from four cameras;

FIG. 2D shows a display screen on a dashboard provided to display videos from six cameras;

FIG. 2E shows a display in which a driver desires to display only one of the video streams on the dashboard display, where the display aspect ratio is different from that in each of the allocated display areas in FIG. 2C or FIG. 2D;

FIG. 3A shows an illustration of storing a period of video streams in a local storage device;

FIG. 3B shows that there are n video streams being coupled to n allocated storage spaces via n circuits controlled by sensors disposed around the vehicle;

FIG. 4A shows a flowchart or process of processing a set of video streams for subsequent uses according to one embodiment of the present invention; and

FIG. 4B shows a configuration in which a service provider providing remote services to a plurality of vehicles via a wireless network.

### DETAILED DESCRIPTION OF THE PREFERRED EMBODIMENTS

The detailed description of the invention is presented largely in terms of procedures in terms of procedures, steps, logic blocks, processing, and other symbolic representations that directly or indirectly resemble the operations of data processing devices that may or may not be coupled to networks. These process descriptions and representations are typically used by those skilled in the art to most effectively convey the substance of their work to others skilled in the art. Numerous specific details are set forth in order to provide a thorough understanding of the present invention. However, it will become obvious to those skilled in the art that the present invention may be practiced without these specific details. In other instances, well known methods, procedures, components, and circuitry have not been described in detail to avoid unnecessarily obscuring aspects of the present invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams, if any, representing one or more embodiments of the invention do not inherently indicate any particular order nor imply any limitations in the invention.

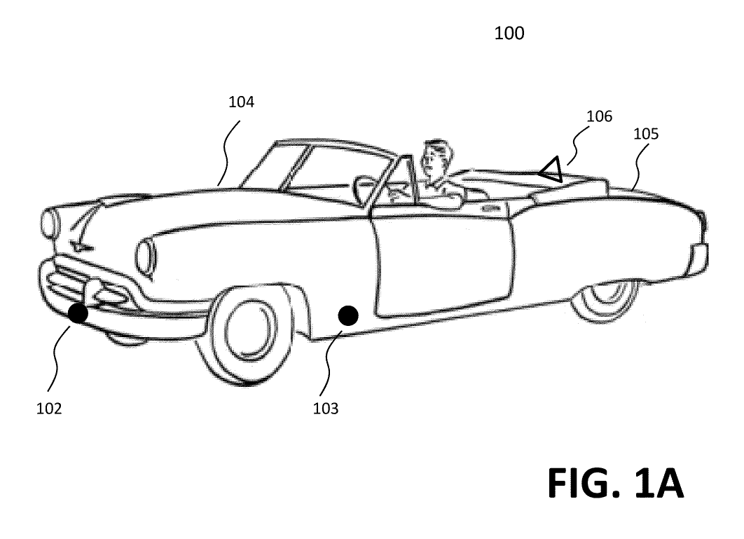

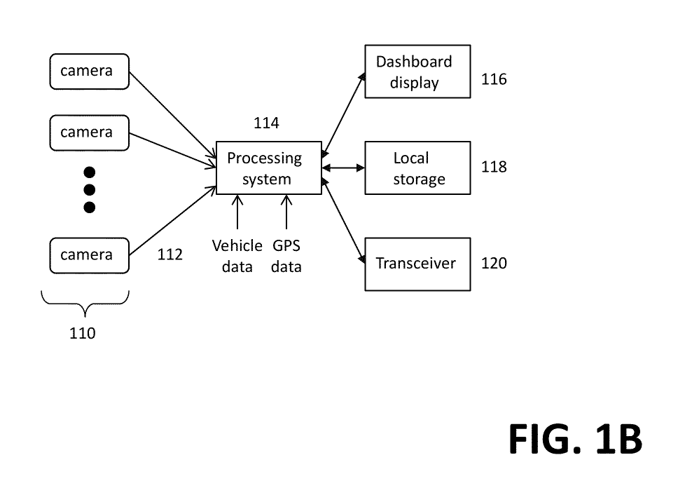

Referring now to the drawings, in which like numerals refer to like parts throughout the several views. FIG. 1A shows an exemplary vehicle 100 equipped with one embodiment of the present invention, referred to as surrounding vehicle video system (SVVS) herein, that provides at least some of the objects, services or benefits in the present invention. As shown in FIG. 1A, the vehicle is equipped with a set of cameras. Depending on what type a vehicle is, there may be two, four, six, eight or even more cameras mounted around the vehicle 100. As an example, four cameras 102-105 are able to provide a surrounding view representing a scene in which the vehicle is present. Such a surrounding view may also be referred to as an outward surrounding view from the vehicle as opposed to a surrounding view of the vehicle.

As will be more detailed below, the captured videos or images from these cameras 102-104 can be stored or transmitted via an antenna 106 to a remote server (not shown). According to one embodiment, such an antenna is part of an antenna of a GPS device in the vehicle 100. In other words, the vehicle includes a transceiver or a modem provided to couple the vehicle or a device or system thereof to a wireless network provided by a carrier. As will be further described below in one embodiment, the vehicle may generate its own wireless local area network so that many digital devices including the cameras 102-104 can be coupled thereon.

Referring now to FIG. 1B, it shows a functional block diagram 110 of an SVVS according to one embodiment of the present invention. The system 110 includes a set of cameras 111, a transmission medium 112, a video processing system 114, and one or more of a dashboard display 116, a local storage device 118 and a transceiver 120. Depending on implementation, the cameras 111 may be CMOS (Complementary metal-oxide-semiconductor) cameras or CCD (Charge-coupled-device) cameras, the transmission medium 112 may be cables or a wireless network to transport the video analog signals or digital video data from the cameras 111 to the video processing system 114. The output from the video processing system 114 can be displayed collectively or respectively on a display screen 116 typically mounted in the dashboard of the vehicle 100, archived in the local storage device 118 or uploaded to a remote server by the transceiver 120.

According to one embodiment, the vehicle 100 is equipped with a GPS (global positioning system) device that provides location and time information of the vehicle. Each of videos or images from the cameras 111 is embedded with the GPS data so that each frame of the images can be readily read to determine which direction the vehicle is going and when the frame is taken when there is a need. Optionally, the images may also be embedded or attached with some profile data of the vehicle such as VIN (vehicle identification number), speed at the time a frame is taken, whether the brake pedal or acceleration pedal is applied, the status of headlights and air bags if any. In one embodiment, an audio signal capturing conversations in the vehicle is synchronized with the video streams being generated from the cameras 111.

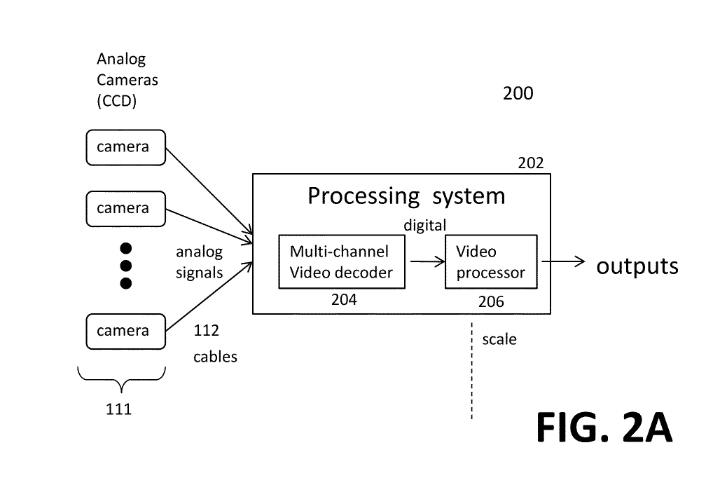

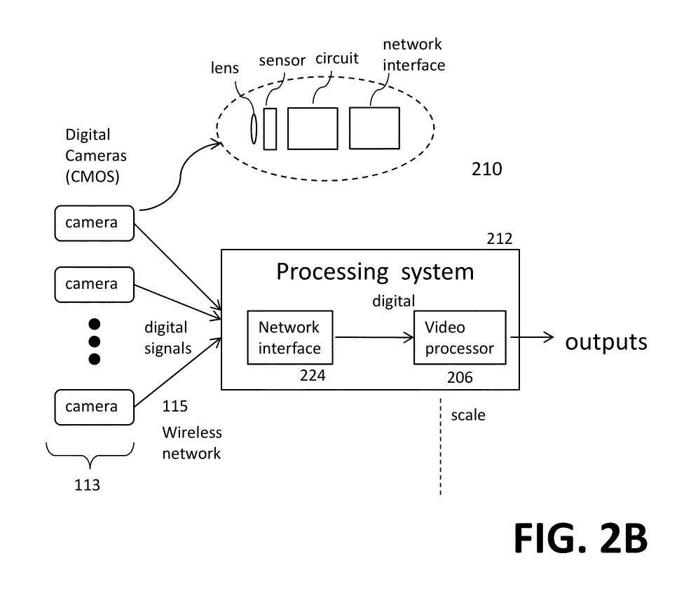

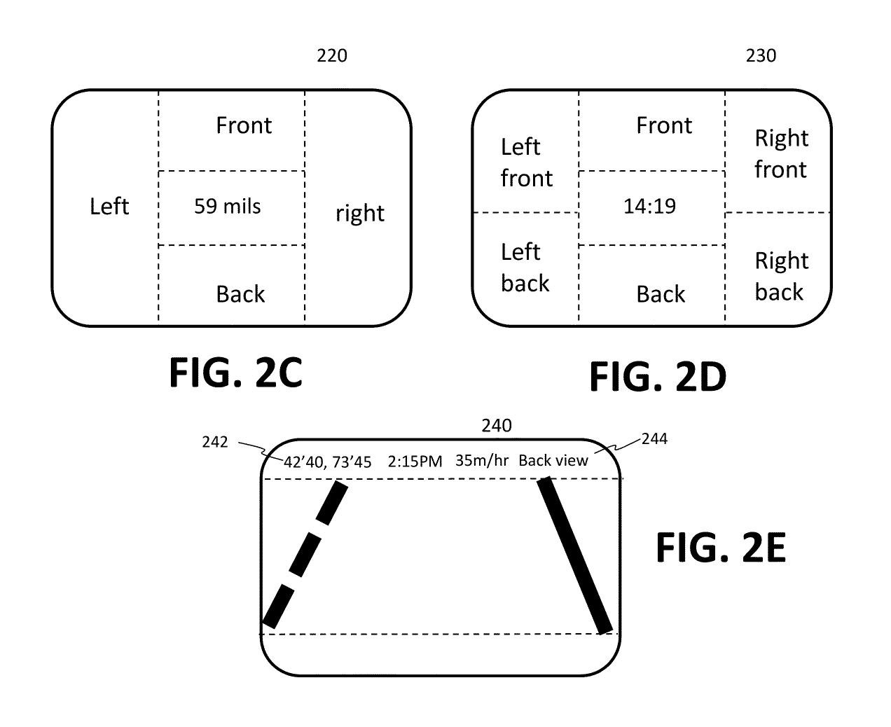

FIG. 2A shows an exemplary functional block diagram 200 of part of an SVVS using a set of analog cameras. An analog camera is defined to be a camera outputting an analog signal. For example, a CCD-based camera is often an analog camera if no post-processing circuitry is provided. The analog (video) signals from the set of cameras 111 are transported to a processing system 202 via a set of cables (e.g., RG-6 coaxial cable). According to one embodiment, the processing system 202 is disposed near the front of the vehicle (e.g., near the dashboard). While the cameras 111 are disposed around the vehicle to capture an outward surrounding view, the produced analog video signals are transported by cables to the processing system 202, where the video signals are processed to produce proper outputs.

According to one embodiment, the (analog) video streams from the cameras 111 are coupled to a multi-channel video decoder (e.g., TW2864 from Techwell Inc. in San Jose, Calif., USA) that is provided to convert the video analog streams to corresponding digital video streams, namely each of the digital video streams is represented in three primary colors (e.g., Red, Green and Blue). The digital streams are further processed in one or more video processor(s) 206. Depending on implementation, the streams are processed according to the nature of the input and what types of outputs are desired.

In one embodiment, the video streams from the cameras 111 are optically distorted, so are the converted digital streams, because the at least one of the cameras 111 uses a fisheye lens that is a wide-angle lens and takes in a broad, panoramic and hemispherical image. Thus many parts of the images are optically distorted to accommodate the wide-angle scene. One or more of the converted digital streams are thus processed to correct the optical distortions based on the optical characteristics of the cameras 111. In addition, the converted digital streams may be processed to increase the dynamic range of the images to enhance the details in relatively too dark or too bright areas in the images.

According to one embodiment, the video processor 206 is configured to provide scaling functions. As shown in FIG. 2C, a display screen 220 on a dashboard is provided to display collectively videos from four cameras while FIG. 2D shows that a display screen 230 on a dashboard is provided to display collectively videos from six cameras. To accommodate multiple videos on a signal display while maintaining graphically positions of the corresponding cameras, a video or image for a designated display will have to be rescaled according to the corresponding allocated display area on the screen. Thus the video processor 206 is configured to scale each of the video streams according to their display locations and corresponding display ratios on the display.

In one embodiment, each of the digital streams represents an aspect ratio (e.g., 4:3 or 16:9). A driver of the vehicle desires to see all videos based on the preconfigured display profile as shown in FIG. 2C or FIG. 2D, a display aspect ratio M:N for each of the display areas in the display screen is thus defined. The video processor 206 is configured to rescale each of the video streams per the display aspect ratio for each of the display areas in the display screen. When the driver desires to display only one of the video streams on the dashboard display as shown in FIG. 2E, a different aspect ratio is detected. The video processor 206 is configured to rescale the corresponding video stream using the updated aspect ratio to fit an allocated display area of the display screen on the dashboard. There are many ways to rescale an image, the details of rescaling an image is not to be provided herein to avoid obscuring important aspects of the present invention.

Although not necessary, the display in FIG. 2E carries more data information than that of FIG. 2C or FIG. 2D. One of the reasons is that the display area of one video stream is larger than that in FIG. 2C or FIG. 2D. Accordingly, the video processor 206 in one embodiment is configured to determine when to present the data information in an image frame, such as the direction 242 the corresponding camera is facing and which camera 242 the video stream is coming from. Optionally, the data information may be suspended from displaying in the image by activating a key (e.g., a physical button or a touch-screen key).

Referring back to FIG. 2B, it shows an exemplary functional block diagram 210 of part of an SVVS using a set of digital cameras 113. A digital camera is defined to be a camera outputting a digital signal (video stream). For example, a CMOS-based camera normally outputs digital signals if no post-processing circuitry is provided to convert the digital signals to analog signals.

An explored showing 212 of a digital camera illustrates that the digital camera includes a network interface that converts the digital signals into data packets for routing over a wireless network 115. According to one embodiment, an ad-hoc or a wireless local area network is created for a vehicle. The wireless local area network has its own unique identifier so that other devices coupled to the wireless network can communicate with each other. On application for such a wireless local area network is to communicate with a sensor in a tire. Instead of having a wired connection between the tire sensor and a measurement device often near the dashboard, the wireless network allows wireless communication between the sensor and the measurement device to determine whether the tire pressure is normal or needs attention from the driver.

It should be noted that the digital camera as illustrated in FIG. 2B is an extended version of a normal camera as it includes a network interface to facilitate the digital camera to communicate with other devices coupled to the network. As shown in 212 of FIG. 2B, a digital output from the sensor is preprocessed in a circuit that further includes a compression unit (e.g., H.264). The compression unit (not shown) is configured to compress the digital video stream from the camera for data communication over the network 115. In one embodiment, the data streams are converted to data packets that are destined, perhaps with a local IP address, to the processing system 212 for further processing. Similarly, the processing system 212 includes a corresponding network interface 224 that receives the data packets and recovers the video streams for similar processing in the video processor 206. The functions of the video process 206 have been described when FIG. 2A is described above.

FIG. 2B shows an embodiment using a local wireless network to transport video streams from digital cameras to a video processing system. One of the features in FIG. 2B is the mechanism provided to allow a user to install additional cameras without undergoing the installation. In one embodiment, the processing system 212 is configured to display an interface allowing the user to discover a newly installed camera and integrate the camera as a member of the surrounding cameras to provide functions as desired. Such interface or mechanism provides the convenience to install other network-interfaced devices (e.g., digital TV, smart phone, or computing device). In addition, the wireless network 115 can be coupled to a wide area network or a wireless network operated by a carrier or a service provider.

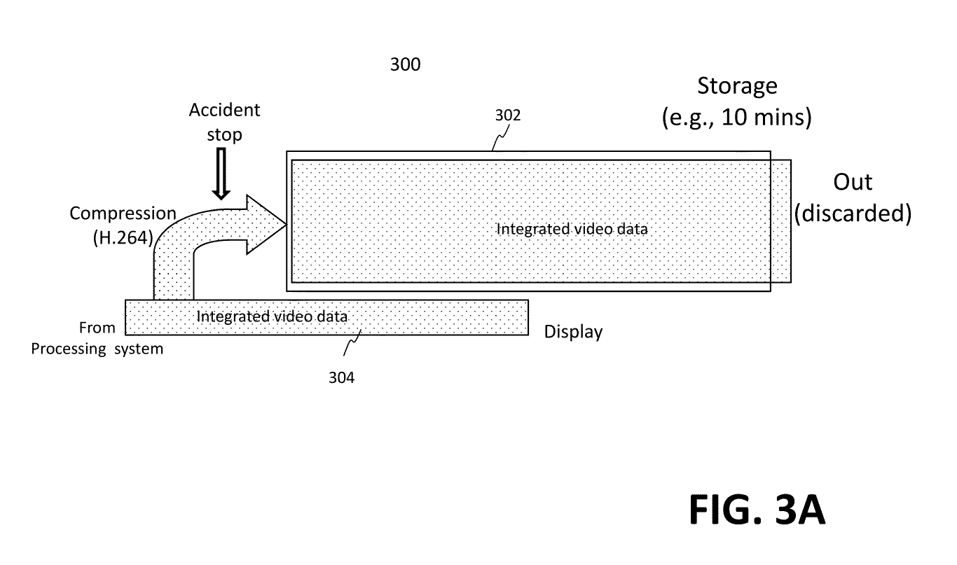

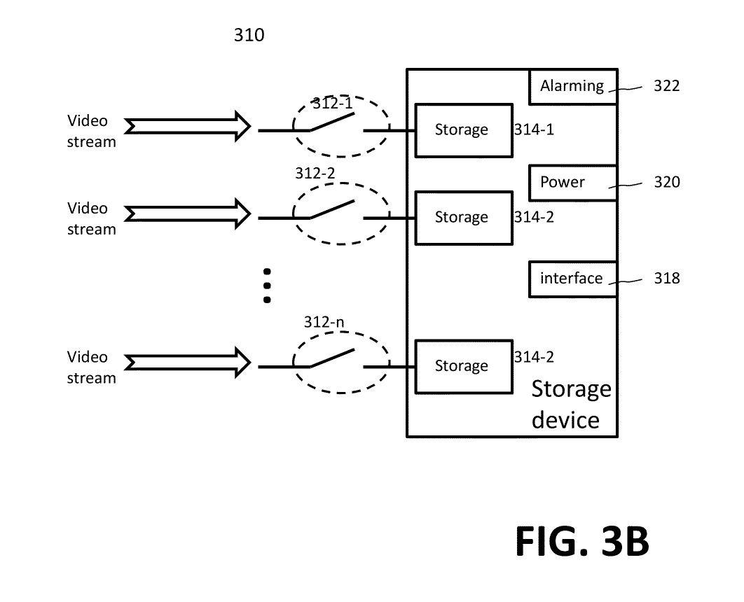

Referring now to FIG. 3A, there shows an illustration 300 of storing a period of video streams in a local storage device. As shown in FIG. 2A, the processing system 202 produces processed digital video streams, each of the streams is coupled to a storage device having a limited storage capacity 302. In one embodiment, the storage device is based on solid-state memory chips (e.g., flash memory). The capacity is large enough to hold a few minutes of data of each of the digital video streams (e.g., 2 minutes). The operation of the storage device is based on first-in-first-out (FIFO). That means a data stream coming from the processing system 202 or 212 is split into two directions, one going to a dashboard display and the other going to a compression engine (not shown) for data compression before stored in the storage 302.

As the cameras operate and the data streams are coming, the data that is already in the storage 302 is pushed out for the new data. To prevent useful data from being pushed out in an event (e.g., car accident), the storage 302 is instantly protected by a control that stops the data from further entering or being saved in the storage 302 upon the vehicle having an impact (e.g., a hit by another vehicle, hitting an object, or any impact exceeding a normal threshold).

FIG. 3B shows that there are n video streams being coupled to n allocated storage spaces 314-1, 314-2 . . . 314-n via n circuits controlled by sensors disposed around the vehicle. According to one embodiment, the storage spaces 314-1, 314-2 . . . 314-n are part of a storage device 316 that is designed to be heavy duty to keep the data saved intact. For example, the device 314 or an enclosure thereof may be fire, water and shock proof. In a crash, the storage device 316 protects the data already saved therein, where the data can be late retrieved via an interface 318 (e.g., an USB interface or a transceiver).

According to another embodiment, the storage device 316 is enclosed in an enclosure that also includes a battery pack 318. Optionally, there is an alarming unit 322 that beeps or sends an alarming signal periodically to allow a detector to locate it should the enclosure be separated from the vehicle in an accident. In any case, the battery pack 318 can always be charged in a normal situation and only be used when the enclosure is no longer with the vehicle.

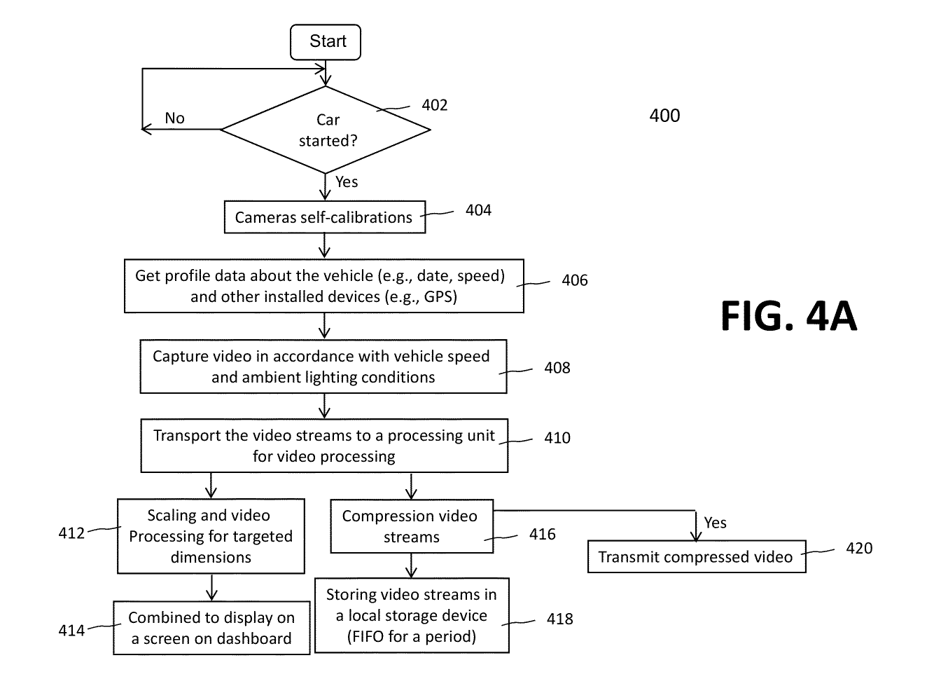

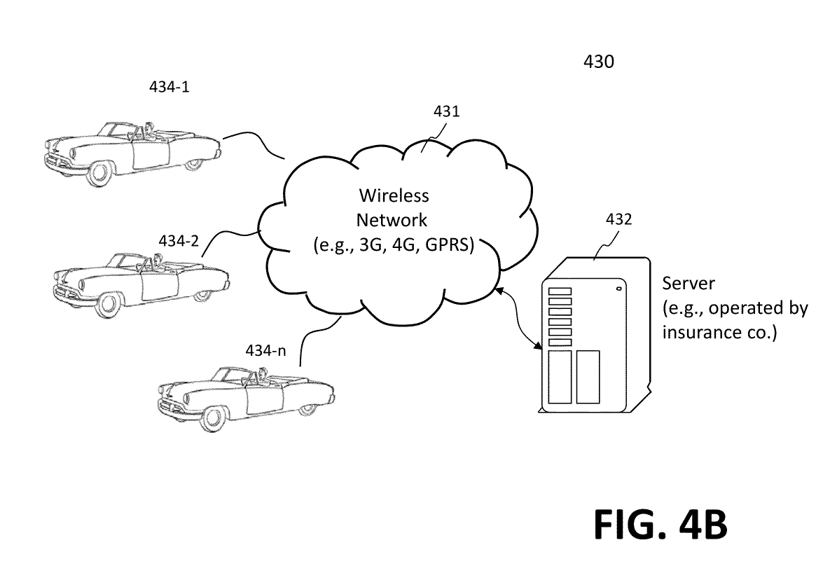

Referring now to FIG. 4A, it shows a flowchart or process 400 of processing a set of video streams for subsequent uses according to one embodiment of the present invention. The process 400 may be further understood in conjunction with the proceeding drawings.

In general, the process 400 starts when a vehicle is ignited. In other words, when the vehicle is started, the cameras disposed around the vehicle are caused to start capturing images collectively representing outward surrounding views from the vehicle. The process 400 now moves to 404, where the installed cameras are activated to perform some self calibrations, for example, to check if all cameras are in working order and indicate to the driver if one of the cameras is not working properly.

While the vehicle starts to accelerate or decelerate, move forwards or backwards, profile data of the vehicle is collected at 406. Examples of the profile data include date, time, vehicle speed, moving direction, tire pressure, temperature if any, and GPS data if there is a GPS device attached. At the same time, the cameras are on and capturing the scene surrounding the vehicle at 408.

As the vehicle is driven forward or backward, each or some of the cameras may be respectfully set to capture a video in accordance with the speed of the vehicle. In an exemplary case, the cameras disposed on the front and back of the vehicle may be set slightly different from the cameras on the sides. Typically, the side cameras would generate more blurred videos than the front and rear cameras when the vehicle is moving at high speed.

Nevertheless, when a vehicle is moving at a high speed (e.g., 80 miles/hour), the regular shutter speed of a camera has to be adjusted faster (i.e., the exposure time is shorter and the exposure is compensated by an adjusted iris). To generate clear pictures while moving at high speed, each of the cameras may be automatically adjusted to produce videos clear enough to reconstruct the scenes surrounding the vehicle prior to a major impact to the vehicle.

Likewise, when the vehicle is moving in a dark area, the cameras are also automatically adjusted to accommodate the low lighting conditions surrounding the vehicle. In one embodiment, some or all of the cameras may be provided additional lighting from embedded LEDs (e.g., some infrared LEDs generating lighting not visible to human eyes but sensitive to the cameras).

In any case, it is assumed that the video is generated from 410 and processed in a video system (e.g., the video system 202 or 212). Depending on the use of the outputs from the video system, various video processing may be implemented in the video system. At 412, each of the video streams from the cameras is corrected according to the optical characters of the optical lens being used and scaled according to a corresponding display area allocated on the dashboard display. The scaled images are then combined to fit into the display screen for continuous display till there is a change of the display configuration that causes the scaling to change.

As the same time, the upcoming video streams are respectively compressed (e.g., using an H.264 engine) and stored in a fashion of FIFO in a memory storage device with a predefined capacity for a limited period. The storage device is protected by a switch that shuts off the incoming video data or the operation of the storage device upon the vehicle having experienced a major impact to protect the data already in the storage device.

According to one embodiment, the vehicle is equipped with a network ring (e.g., an ad-hoc wireless network) that is coupled with a wireless network provided by a service provider. An example of such a wireless network is a WIFI network, a LTE network, a 3G network or a general packet radio service (GPRS) network. The compressed video from 416 may be authorized to upload to a server coupled to the wireless network.

In one case, an insurance company manages a video server coupled to a network to receive the compressed surrounding view of the vehicle. Depending on the implementation, the insurance may or may not get an authorization from the owner of the vehicle to download the stored video data to access any damages the vehicle may have after an accident. According to one embodiment, the storage device as shown in FIG. 3B may be designed to include a wireless modem that can be activated in an event to be coupled to a wireless network (e.g., an LTE network) to upload the stored compressed video data to a designated server.

In another case, a remote assistance may be provided by using one embodiment of the present invention. For example, a driver needs to find a particular place from a current location when the GPS in the vehicle fails to provide a proper guidance in which a remote assistant service may guide the driver to the location being sought in accordance with the uploaded videos.

FIG. 4B shows a configuration 430 in which a service provider providing remote services to a plurality of vehicles 434-1, 434-2, . . . , 434-n via a wireless network 431. Data from any of the vehicles 434-1, 434-2, . . . , 434-n is identified by a unique identifier (ID) so that a service provider operating the server 432 knows exactly which vehicle is uploading the data. Besides the video data as described above, the data may also include other related information about the vehicle, such as vehicle profile data, to facilitate a remote site to perform a designated task (e.g., remote assistance or scene reconstruction). In one embodiment, the server 432 is executing a module configured to automatically reconstruct a panoramic scene from the uploaded video streams to allow an operator to see exactly what is happening or happened, provided the driver authorizes such uploading.

In one embodiment for remote security, a driver of a vehicle allows the cameras to be on while the vehicle is parked in a public place. The videos are transported to a remote site for monitoring. Should there be an unwanted approach to the vehicle (e.g., someone trying to crack the window glass to access the compartment), the alarm of the vehicle could be remotely set off or the driver is alerted.

The present invention has been described in sufficient detail with a certain degree of particularity. It is understood to those skilled in the art that the present disclosure of embodiments has been made by way of examples only and that numerous changes in the arrangement and combination of parts may be resorted without departing from the spirit and scope of the invention as claimed. While the embodiments discussed herein may appear to include some limitations as to the presentation of the information units, in terms of the format and arrangement, the invention has applicability well beyond such embodiment, which can be appreciated by those skilled in the art. Accordingly, the scope of the present invention is defined by the appended claims rather than the foregoing description of embodiments.

1. A monitoring system for a vehicle, the monitoring system comprising:
a plurality of cameras disposed around the vehicle to generate video streams about a scene surrounding the vehicle;
a video processing device;
a display screen on a dashboard of the vehicle; and
a transmission medium to transport the video streams from the cameras to the video processing device for processing to be collectively displayed on the display screen, wherein some or all of the video streams are respectively displayed in allocated display areas of the display screen, the display areas are reconfigurable to accommodate more or less of the video streams, and wherein the some or all of the video streams provide a driver of the vehicle an outward surrounding view of the vehicle.

2. The monitoring system as recited in claim 1, wherein each of the cameras produces an analog video signal, and the transmission medium is a plurality of cables to respectively couple the cameras to the video processing device.

3. The monitoring system as recited in claim 2, wherein the video processing device includes one or more multi-channel video decoders to convert the analog video signal of each of the cameras to a set of digital signals to be processed in the video processing device.

4. The monitoring system as recited in claim 2, wherein each of the cameras produces an digital video signal, and the transmission medium is a wireless local area network, each of the cameras includes an interface that couples the each of the cameras to the wireless local area network and transports the digital video signal of the each of the cameras wirelessly to the video processing device.

5. The monitoring system as recited in claim 4, wherein the each of the cameras includes a compression engine configured to compress the digital video signal thereof before transporting the digital video signal to the video processing device via the wireless local area network.

6. The monitoring system as recited in claim 5, wherein the wireless local area network is coupled to a carrier network to receive data from a remote server or to send data to a remote server.

7. The monitoring system as recited in claim 1, wherein the video streams are in digital form, and the video processing device includes or is coupled to a compression engine configured to compress the video streams, and the vehicle further comprising a data record device, designed to store data of a predefined period, configured to receive the compressed video streams in a first-in-first-out fashion to retain the predefined period of the compressed video streams.

8. The monitoring system as recited in claim 7, wherein the data record device is coupled to a set of sensors and shut off upon the vehicle experiencing a major impact to protect what has already been stored in a storage device enclosed in the data record device.

9. The monitoring system as recited in claim 8, wherein the data record device includes an alarming unit to send an alarming signal to tell a detector where the data record device is located.

10. The monitoring system as recited in claim 9, wherein the data record device further includes a wireless modem that facilitates uploading of stored data therein to a remote server.

11. A monitoring system for a vehicle, the monitoring comprising:
a storage device;
a video processing unit configured to receive video streams from at least two cameras disposed around the vehicle, the video processing unit is further configured to compress the video streams and couple the compressed video streams to the storage device, where the storage device has a storage capacity to store video data of a predefined period, the compressed video streams are stored in the storage device in FIFO (first-in-first-out) fashion; and
wherein the storage device is coupled to a set of sensors and stops from taking the compressed video streams upon any of the sensors detecting an impact to the vehicle to preserve the data already in the storage device.

12. The monitoring system as recited in claim 11, wherein the cameras produce respectively a set of analog video signals, and the analog video signals transported to the video processing unit via a set of coaxial cables.

13. The monitoring system as recited in claim 12, wherein the video processing unit includes one or more multi-channel video decoders to convert the analog video signals to a set of digital video streams for further processing therein.

14. The monitoring system as recited in claim 13, wherein the video processing unit is configured to rescale the digital video streams according to respective display ratios to collectively display the digital video streams on a single display screen, wherein the display screen is defined to include a set of display areas, each for one of the cameras, each of the display areas corresponds to one of the display ratios.

15. The monitoring system as recited in claim 11, wherein the cameras produce respectively digital video signals, the digital video signals are transported to the video processing unit via a wireless local area network created specifically to the vehicle, and wherein each of the cameras includes an wireless interface to couple the each of the cameras to the wireless local area network.

16. The monitoring system as recited in claim 15, wherein the wireless local area network is coupled to a wireless network provided by a carrier so that some or all of the digital video signals after compressed in the video processing unit can be uploaded to a designed remote server.

17. The monitoring system as recited in claim 15, the video processing unit is configured to rescale the digital video streams according to respective display ratios to collectively display the digital video streams on a single display screen, wherein the display screen is defined to include a set of display areas, each for one of the cameras, each of the display areas corresponds to one of the display ratios.

18. The monitoring system as recited in claim 11, further including a modem configured to couple the monitoring system to a wireless network, and wherein the storage device is activated to cause the preserved data in the storage device to be uploaded to a designed remote server.

19. The monitoring system as recited in claim 11, wherein each of the video streams is embedded with a set of profile data about the vehicle, the compressed video streams stored in the storage device can be used to reconstruct a scene surrounding the vehicle at the time the compressed video streams are generated respectively from the cameras.

20. A method for monitoring a vehicle, the method comprising:
generating video streams from at least two cameras disposed around the vehicle;
coupling the video streams to a video processing unit configured to compress the video streams;
storing the compressed video streams in the storage device, where the storage device has a storage capacity to store video data of a predefined period, the compressed video streams are stored in the storage device in FIFO (first-in-first-out) fashion; and wherein the storage device is coupled to a set of sensors and stops from taking the compressed video streams upon any of the sensors detecting an impact to the vehicle to preserve the data already in the storage device.
